(19) United States
(12) Patent Application Publication
(10) Pub. No.: US 2006/0074636 A1
(43) Pub. Date: Apr. 6, 2006

(54) Language learning system and method

(75) Inventors: Jenny Xu, Taipei (TW); Chaucer Chiu, Taipei (TW)

Correspondence Address: EDWARDS & ANGELL, LLP, P.O. BOX 55874, BOSTON, MA, 02205, US

(73) Assignee: Inventec Corporation, Taipei (CN)

(21) Appl. No.: 10/987,999

(22) Filed: Nov. 12, 2004

(30) Foreign Application Priority Data
Sep. 29, 2004 (TW) 093129380

(51) Int. Cl. G06F 17/21

(52) U.S. Cl. 704/10

(57) ABSTRACT

A language-learning system and a method thereof are provided. The system includes a memory unit for storing learning data comprising a first databank for storing exercise data and a second database for storing lookup data, an operating interface for users to input commands, a functional module for performing processes according to the commands input by the users and extracting corresponding exercise data according to the lookup data obtained from the first databank, and an output module for displaying the exercise data and results of processes of the functional module, thereby allows users to select an appropriate exercise level for themselves and provides a language learning interface with correction functionality for users to increase the learning efficiencies of language.

### FIELD OF THE INVENTION

The present invention relates to a language learning technique, and more particularly, to a language learning system and method for improving user's verbal ability.

### DESCRIPTION OF THE PRIOR ART

Language is one of the ways human communicate, the fast development of technologies has propel people to learn a second language other than their native tones in order to conveniently communicate with rest of the world.

Conventionally, languages are taught by human teachers, with the help of written materials. The requirement of a cooperation of time between students and teachers in this conventional way is not very suitable for people nowadays with busy schedules.

Through the use of electronic language learning system, this problem can be solved. For example, computers have powerful multimedia functions that allow users, at their free time, to not only learn a language through reading and writing, but also through sound, which increases the user's listening skills and helps memorization.

Currently, there are two main kinds of language-learning tools; one extracts data in unit of a word/phrase, which functions as a phono-dictionary for user to lookup, however it lacks the interaction that facilitates memorization. The other kind of language-learning tool extracts data in unit of a story, so that what need to be memorized are determined after the user has read through the story. This, however, is time consuming. Thus, it is necessary to find a balance between these two kinds of language-learning tools.

In addition to the above language-learning tools having disadvantages in data extraction thereof, they also fail to provide users a chance to practice and correct mistakes, which present another disadvantage for these language-learning tools.

Therefore, there is a need for a more efficient language-learning tool that provides users with dynamic learning opportunities and more convenient way of extracting data.

### SUMMARY OF THE INVENTION

In order to solve the problems of the prior art, a primary objective of the present invention is to provide a language-learning system and method, so that users can extract learning data more conveniently.

Another objective of the present invention is to provide a language-learning system and method, which is able to correct mistakes entered by the user, hence giving users a chance to learn from mistakes.

In order to achieve the above objectives, the present invention provides a language-learning system and method. The system comprises: (1) a memory unit for storing data, it further comprises a first databank for storing exercise data and a second databank for storing lookup data; (2) an operating interface for users to enter commands; (3) functional module for processing data according to the commands inputted from the interface; and (4) output module for displaying exercise data and processed output by the functional module.

In addition, the language-learning method of the present invention is used in the language-learning system, the method comprises: (1) storing exercise data and lookup data in the language-learning system in advance; (2) providing an operating interface for user to input commands; (3) extracting exercise data corresponding to the lookup data, and performing operations corresponding to the commands inputted by the user; (4) displaying the exercise data and processed result of the operations.

Comparing to the conventional techniques, the language-learning system and method of the present invention extracts and provides data from the memory unit in a more convenient way, and users are allowed to enter control commands via the operating interface for practicing and correcting mistakes, hence enhances user's interest and efficiency in learning.

### BRIEF DESCRIPTION OF THE DRAWINGS

FIG. 1 is a block diagram showing the basic structure of the language-learning system according to the present invention.

FIG. 2 is a flow diagram showing the language-learning method according to the present invention.

FIG. 3a to 3e show the operating windows of the language-learning system according to the present invention.

### DETAILED DESCRIPTION OF THE PREFFERED EMBODIMENT

The descriptions below of specific embodiments are to illustrate the present invention. Others skilled in the art can easily understand other advantages and features of the present invention from contents disclosed in this specification. The present invention can be carried out or applied through different embodiments. Every details of this specification can be modified based on different viewpoints and applications yet still within the scope of the present invention.

In the following embodiment, the language-learning system is applied to an English learning environment. As mentioned above, this embodiment is only used to disclose the advantages and functions of the present invention, and not to limit the language type to which the present invention may apply.

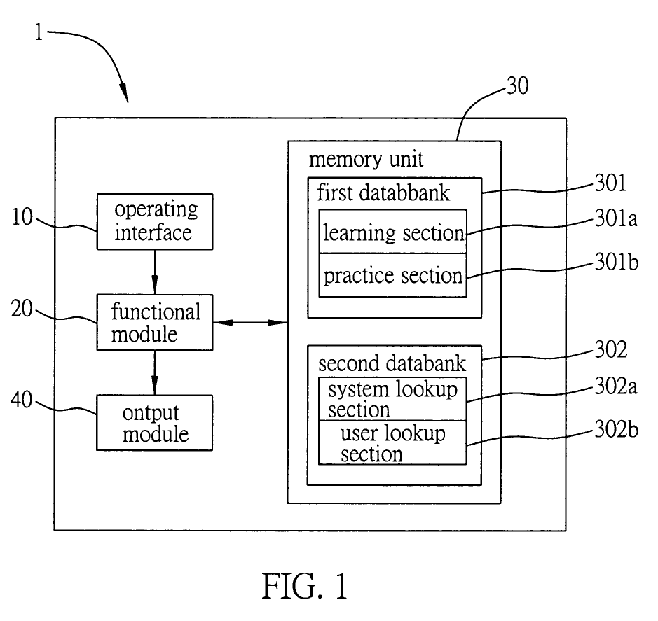

FIG. 1 shows the basic structure of the language-learning system 1 of the present invention. As shown in FIG. 1, the language-learning system 1 comprises an operating interface 10, a functional module 20, a memory unit 30, and an output unit 40.

The memory unit 30 for storing data further comprises a first databank 301 for storing exercise data and a second databank 302 for storing lookup data. The exercise data stored in the first databank 301 can be literal data or voice data. In this embodiment, the literal data are the English data and its Chinese translation. The translation does not limit to Chinese, but in practice can be other types of languages. Moreover, the first databank 301 is further divided into a learning section 301a and a practice section 301b. The second databank 302 also further comprises a system lookup section 302a for storing system lookup data, and a user lookup section 302b for storing user's lookup data.

The operating interface 10 allows users to input control commands for operation. The functional module 20 performs the processes instructed by the control commands inputted from the operating interface 10. It also determines lookup data from the system lookup section 302a of the second databank 302, and extracts literal data corresponding to the lookup data in unit of a sentence from the learning section 301a of the first databank 301.

The output module 40 is sued to output the exercise data stored in the first databank 301, and the results of process of the functional module 20.

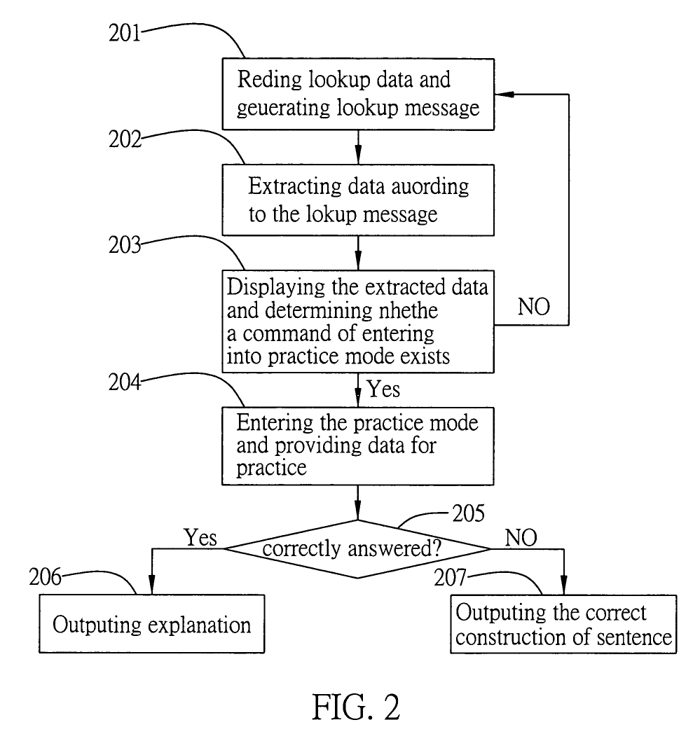

FIG. 2 shows the operational flow diagram of the language-learning method of the present invention. Firstly, the functional module 20 reads a lookup data from the second databank to generate a lookup message. There are two lookup modes: automatic lookup and set lookup. The set lookup further comprises a “set system lookup” and a “set user lookup”. The set system lookup means that the user sets the lookup data to be read from the system lookup section 302a via the operating interface 10 for generating lookup message. For example, the system lookup section 302a uses the word “what” as the lookup data to generate lookup message for a sentence starting with the word “what”. The set user looks up data from the user lookup section 302b to generate a lookup message. In comparison, the automatic lookup randomly looks up data from the system lookup section 302a to generate a lookup message. In step 201, it should also be noted that the lookup data is in unit of a word/phrase. However, in actual practice, other data or means that achieve the functions of lookup can be used. Then, proceed to step 202.

In step 202, the functional module 20 extracts literal message corresponding to the lookup message from the first databank 301 in unit of a sentence. The literal message can be an English sentence and the translation thereof. In this step, if the user inputs voice data and control command, the functional module 20 extracts the English sentence corresponding to the voice data from the first databank 301. Then proceed to step 203.

In step 203, the output module 40 outputs the extraction result from the function module obtained in step 202, and determines whether there is a command for entering practice mode. If so, enter into the practice mode and proceed to step 204; else, return to step 201. The extracted English sentence and its translation can be outputted simultaneously or alternately. The time for simultaneous or alternating display can be set.

In step 204, the practice mode is entered and the level of practice can be set by the user through the operating interface 10, so that an appropriate level of practice data can be provided to the user.

In this embodiment, there are six levels corresponding to level of difficulties of the practice data. Literal data for practice can be extracted from the exercise section 301b of the first databank 301 through the functional module 20. The literal data further includes an English sentence, its translation thereof for practice, and at least one English word. The output module 40 outputs the translation and all those words constituting the English sentence in a randomly order, allowing the user to rearrange the words into a sentence according to the suggested translation. Then proceed to step 205.

In step 205, whether the sentence rearranged by the user matches the original sentence is determined. If so, then proceed to step 206; else to step 207.

In step 206, the language-learning system 1 outputs a mark indicating a correct answered (for example, “”) and an annotation about the grammar of this sentence.

In step 207, the language-learning system 1 outputs a mark indicating a wrong answer (for example, “X”) and the correct construction of that English sentence. Then this practice data is stored in the user lookup section 302b.

According to the flow diagram shown in FIG. 2, when the practice mode is entered in step 204, the practice method can be replaced by other means that achieve the same purpose of practicing. For example, some randomly arranged English words could be provided to the user for constructing a new sentence. Then in step 205, whether this new sentence matches any English sentence in the first databank 301 is determined. If so, then output the annotation thereof for user reference in step 206, else outputs the closest English sentence for user reference in step 207. In addition, the level of practice can be divided according to parameters other than level of difficulty of the practice data.

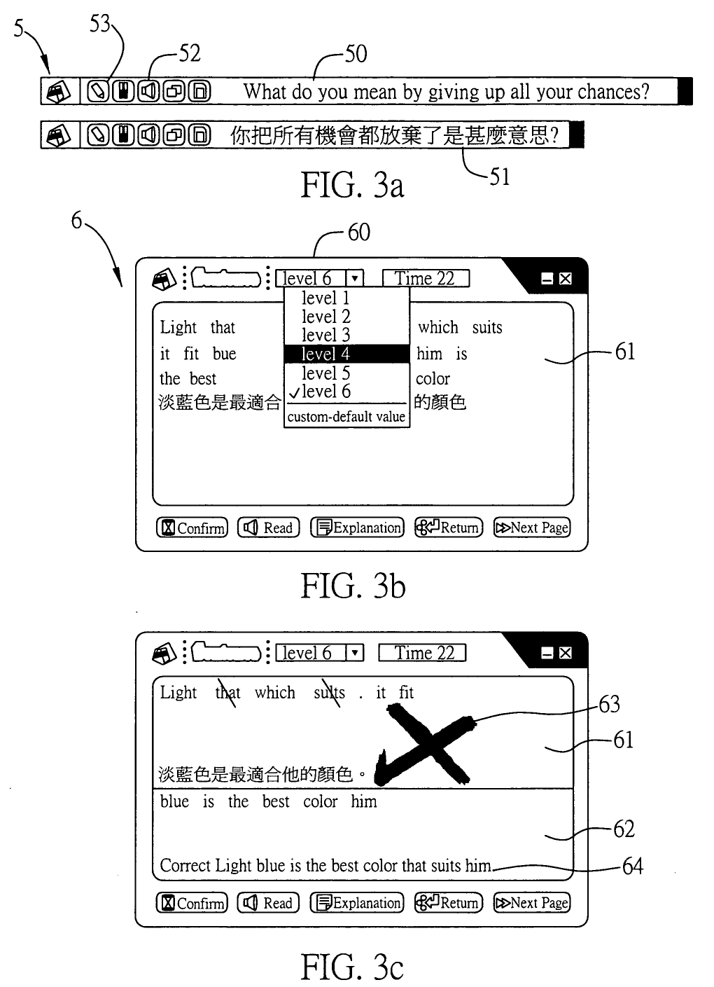

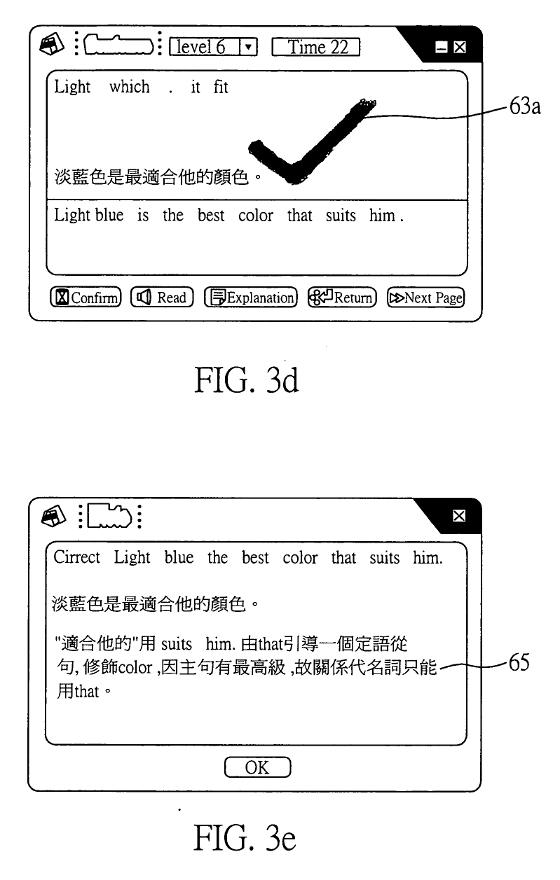

In FIG. 3a to 3e, operating windows according to the present invention are shown. FIG. 3a shows an activating window 5 for the language-learning system 1, wherein an English sentence 50 is a randomly lookup sentence, and the Chinese sentence 51 is the translation of the English sentence 50. User can activate pronunciation command via a pronunciation button 52 to hear the pronunciation of the English sentence 50. In addition, the practice mode can be entered into by activating the practice command via a practice button 53.

FIG. 3b shows some randomly arranged words and the translation thereof for practice in a words display section 61 and a selection menu 60 for selecting practice level when in a practice window 6.

FIG. 3c shows a situation when the user drags words from the words display section 61 to a reconstruction section 62 for sentence reconstruction, and the rearranged sentence does not match the correct English sentence. Therefore, a corresponding error indication mark 63 is displayed to let the user know that it was wrongly answered. Then, a correct reconstruction 64 of the sentence in the reconstruction section 62 and an explanation of grammar as shown in FIG. 3e are provided for the user to learn from the mistake and make improvement.

FIG. 3d shows the case when the user has correctly reconstructed the sentence, i.e. when it matches the correct English sentence in the databank; then a corresponding correct indication mark 63a and the explanation of grammar such as the one shown in FIG. 3e are outputted by the language-learning system 1 to increase confidence of the user.

The embodiments above are only to illustrate aspects of the present invention; it should not be construed as to limit the scope of the present invention in any way.

While the invention has been described in detail with reference to specific embodiments thereof, it will be apparent in the art that various changes and modifications can be made, and equivalents employed, without departing from the scope of the claims.

What is claimed is

1. A language-learning system used in an electronic apparatus, comprising:
a memory unit for storing learning data comprising a first databank for storing exercise data and a second database for storing lookup data;
an operating interface for users to input commands;
a functional module for performing processes according to the commands input by the users and extracting corresponding exercise data according to the lookup data obtained from the first databank; and
an output module for displaying the exercise data and results of processes of the functional module.

2. The language-learning system as claimed in claim 1, wherein the exercise data extracted corresponding to the lookup data obtained from the first databank is extracted in unit of a literal sentence.

3. The language-learning system as claimed in claim 1, wherein the exercise data are literal data and sound data.

4. The language-learning system as claimed in claim 3 wherein the output of sound data is controlled via the input of the operating interface.

5. The language-learning system as claimed in claim 3, wherein the literal data is English data and Chinese translation thereof.

6. The language-learning system as claimed in claim 5, wherein the English data and translation thereof are simultaneously or alternately displayed.

7. The language-learning system as claimed in claim 6, wherein the time of either one of the simultaneous and alternate modes can be set.

8. The language-learning system as claimed in claim 1, wherein the second databank further comprises a system lookup section for storing system lookup data, and a user lookup section for storing user lookup data.

9. The language-learning system as claimed in claim 1, wherein the operating interface is used for the users to select and enter into a practice mode.

10. The language-learning system as claimed in claim 9, wherein in the practice mode, the exercise data are divided into a plurality of levels according to their difficulties.

11. The language-learning system as claimed in claim 9, wherein in the practice mode, words constructing a sentence for practice in the exercise data are randomly outputted.

12. The language-learning system as claimed in claim 11, wherein the outputted words can be reconstructed to form a new sentence.

13. The language-learning system as claimed in claim 11, wherein an explanation of the sentence for practice that matches with the reconstructed new sentence is displayed.

14. The language-learning system as claimed in claim 11, wherein the correct construction of the sentence for practice that mismatches with the reconstructed new sentence is displayed, and this practice data is recorded in the user lookup section of the second databank.

15. A language-learning method for use in an electronic apparatus through a language-learning system, the method comprising the steps of:
storing exercise data and lookup data;
providing an operating interface for users to input commands;
extracting the exercise data corresponding to the lookup data, and performing operation according to the command inputted by the user; and
displaying the result of processing the operations.

16. The language-learning method as claimed in claim 15, wherein the language-learning system comprises one selected from the group consisting of a memory unit, an operating interface, a functional module and an output module.

17. The language-learning method as claimed in claim 16, wherein the operating interface is used for the users to select and enter into a practice mode.

18. The language-learning method as claimed in claim 17, wherein in the practice mode, the exercise data are divided into a plurality of levels according to their difficulties.

19. The language-learning method as claimed in claim 17, wherein in the practice mode, words constructing a sentence for practice in the exercise data are randomly outputted.

20. The language-learning method as claimed in claim 19, wherein the outputted words can be reconstructed to form a new sentence.

21. The language-learning method as claimed in claim 20, wherein an explanation of the sentence for practice that matches with the reconstructed new sentence is displayed.

22. The language-learning method as claimed in claim 20, wherein the correct construction of the sentence for practice that mismatches with the reconstructed new sentence is displayed, and this practice data is recorded in the user lookup section of the second databank.

23. The language-learning method as claimed in claim 15, wherein the lookup data further comprises system lookup data or user lookup section.

24. The language-learning method as claimed in claim 15, wherein the exercise data extracted corresponding to the lookup data is extracted in unit of a literal sentence.

25. The language-learning method as claimed in claim 15, wherein the exercise data are literal data and sound data.

26. The language-learning method as claimed in claim 25, wherein the literal data is English data and Chinese translation thereof.

27. The language-learning method as claimed in claim 26, wherein the English data and translation thereof are simultaneously or alternately displayed.
